(19) United States
(12) Patent Application Publication
(10) Pub. No.: US 2011/0095718 A1
(43) Pub. Date: Apr. 28, 2011

(54) SERVO MOTOR SYSTEM AND OPERATING METHOD OF THE SAME

(76) Inventors: Chin-Shiong Tsai, Taoyuan County (TW); Jian-Da Chen, Taoyuan County (TW); Hong-Cheng Sheu, Taoyuan County (TW)

(21) Appl. No.: 12/605,536

(22) Filed: Oct. 26, 2009

(51) Int. Cl. G05B 19/18

(52) U.S. Cl. 318/569

(57) ABSTRACT

A servo motor system and an operating method of the servo motor system are disclosed. The servo motor system includes a servo motor and a servo driver. The servo motor is electrically connected to the servo driver. The servo motor includes a motor unit and an encoder. The encoder is mechanically connected to the motor unit. The encoder includes a CPU and a memory unit. The memory unit is electrically connected to the CPU. Data parameters are saved in the memory unit. The servo driver uses data parameters of the motor unit saved in the memory unit for controlling the motor unit. The servo motor system and the operating method provide a mechanism to drive and offer compensation to an upgraded motor.

### BACKGROUND OF THE INVENTION

1. Field of the Invention

The present invention generally relates to a motor system and an operating method of the motor system, in particular, to servo motor system and an operating method of the servo motor system.

2. Description of Prior Art

Traditionally, a servo system (servo mechanism) is a mechanical system for controlling position, velocity and acceleration via a close loop. Typically, a servo system often comprises a plant, an actuator and a controller. The plant is the object under control and can be, for example, a mechanical arm or a mechanical platform. The function of an actuator is to provide the driven force to the plant in terms of air pressure, oil pressure or electric drive. When a servo system is driven by oil pressure, it is called an oil pressure servo system. Currently, the majority of servo systems are driven by electric drive.

An actuator comprises a motor and a power amplifier. The motor designed to implement in a servo system is called a servo motor. A servo motor typically comprises a position feedback device, for example an optical encoder, resolver or angle detector/sensor etc. The servo motors frequently implemented in the industrial equipments include direct current (DC) servo motor, permanent magnet alternating current (AC) servo motor and induction servo motor. Among which, the permanent magnet servo motors account for the majority.

The function of a controller is to provide a close loop control for the entire servo system, for example torque control, velocity control and position control. Currently, an industrial servo driver often comprises a controller and a power amplifier.

FIG. 1 is a schematic diagram of a prior art servo motor system. FIG. 2 is a block diagram of a prior art servo motor system. A prior art servo motor system comprises a servo driver 100 and a servo motor 400. The servo motor 400 has an encoder 420 and a motor unit 440. The servo driver 100 is electrically connected to the encoder 420 and the motor unit 440. The servo driver 100 sends current to a stator (not shown in the diagram) of the motor unit 440 for generating a magnetic field to actuate a rotor (not shown in the diagram) of the motor unit 440, wherein the encoder 420 feedbacks the angle of the rotor of the motor unit 440 for generating required three-phase currents.

The motor unit 440 sends the angle of the rotor of the motor unit 440 to the servo driver 100 via means of serial communication or pulses with the encoder 420. An alternative mechanism is the servo motor 400 sending a motor identification code of the servo motor 400 to the servo driver 100 first upon power on. Thus, the servo driver 100 is acknowledged the model number of the servo motor 400. Consequently, corresponding parameters of the motor saved in advance in the servo driver 100 is retrieved and implemented in the control loop.

Nonetheless, the servo driver 100 only recognizes motor identification codes saved in advance in the servo motor 400 of the servo driver 100. Given that the servo driver 100 receives a motor identification code not saved in the servo driver 100, the servo driver 100 does not have required parameters for driving the servo motor 400.

Interior Permanent Magnet (IPM) motor has a magnet disposed inside of the rotor so as to increase performance of torque-velocity for improving motor efficiency. Since 1990, IPM motors are widely applied in various devices such as cars and air conditioners due to its high efficiency. In the near future, IPM motors are expected to gradually substitute the Surface Permanent Magnet (SPM) motors in the servo motor designs.

However, it should be noted that properties of an IPM motor are non-linear, for example the counter-electromotive force is not the sine curve generally. In addition, the above mentioned servo driver 100 has limited storage for saving motor identification codes and as a result is not capable of providing required compensation to several IPM motors. More specifically, the prior art servo driver 100 is not capable of driving an upgraded servo motor 400 without firmware updates.

### SUMMARY OF THE INVENTION

In order to overcome the disadvantage mentioned above, it is an objective of the present invention to provide a servo motor system to provide a mechanism for driving and offering compensation to an upgraded motor.

In order to overcome the disadvantage mentioned above, it is another objective of the present invention to provide an operating method of the servo motor system to provide a mechanism for driving and offering compensation to an upgraded motor.

To achieve the above mentioned objective of the present invention, the servo motor system according to the present invention comprises a servo motor. The servo motor has a motor unit and an encoder. The encoder is mechanically connected to the motor unit. The encoder further comprises a CPU and a memory unit. The memory unit is electrically connected to the CPU. The data parameters are saved in the memory unit.

To achieve another above mentioned objective of the present invention, the servo motor system according to the present invention is implemented with a servo driver and a servo motor. The servo motor comprises a motor unit and an encoder. The encoder has a CPU and a memory unit. The data parameters are saved in the memory unit. The operating method of the servo motor system comprises: the CPU retrieves data parameters of the motor unit from the memory unit; the encoder sends data parameters of the motor unit to the servo driver; and the servo driver controls the motor unit according to the data parameters of the motor unit.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a schematic diagram of a prior art servo motor system;

FIG. 2 is a block diagram of a prior art servo motor system;

FIG. 3 is a block diagram of a servo motor system according to the present invention;

FIG. 4 is a flowchart of operation method of the servo motor system according to the present invention;

FIG. 5 is a schematic diagram illustrating decoupling compensation of servo motor system according to the present invention; and

FIG. 6 is an operating timing diagram of a servo driver and an encoder according to the present invention.

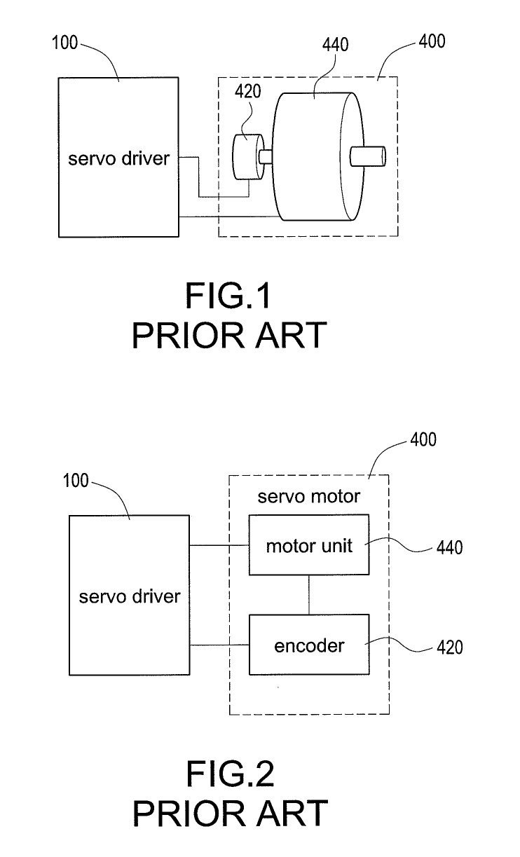

### DETAILED DESCRIPTION OF THE INVENTION

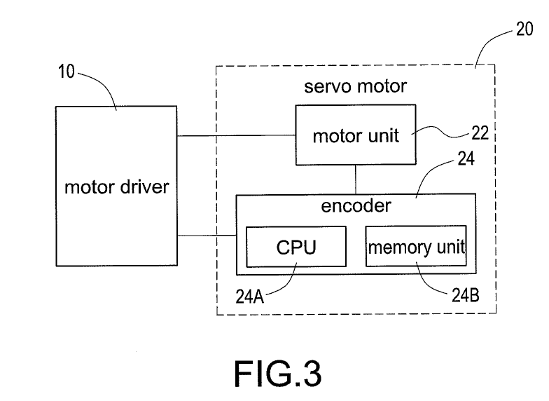

FIG. 3 is a block diagram of a servo motor system according to the present invention. The servo motor system according to the present invention has a servo motor 20 and a servo driver 10. The servo driver 10 is electrically connected to the servo motor 20. The servo motor 20 further includes a motor unit 22 and an encoder 24. The encoder 24 is mechanically connected to the motor unit 22. The encoder 24 further include a CPU 24A and a memory unit 24B. The memory unit 24B is electrically connected to the CPU 24A.

The data parameters of the motor unit 22 are saved in the memory unit 24B and include parameters such as resistance, inductance, counter-electromotive force and detent torque of the motor unit 22 on direct axis (d axis) and quadrature axis (q axis). The servo driver 10 controls the motor unit 22 according to the data parameters of the motor unit 22 saved in the memory unit 24B. The servo motor 20 can be for example an interior permanent magnet (IPM) motor; and the encoder 24 can be for example an absolute encoder.

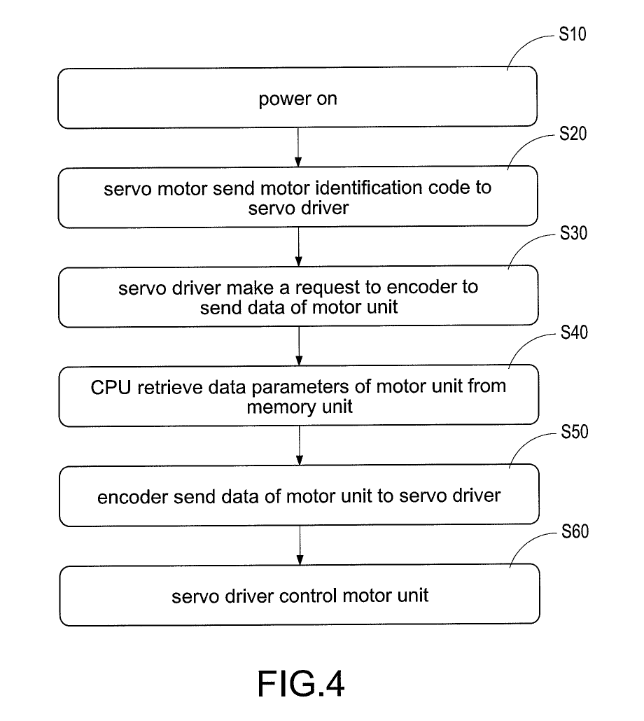

FIG. 4 is a flowchart of operation method of the servo motor system according to the present invention. With references to FIG. 3 and FIG. 4, the steps of the operating method are: power on (step S10), the servo motor 20 sends a motor identification code to the servo driver 10 (step S20), the servo driver 10 make a request to the encoder 24 to send data parameters of the motor unit 22 according to the motor identification code (step S30). Following that, the CPU 24A of the encoder 24 retrieves data parameters of the motor unit 22 from the memory unit 24B of the encoder 24 (step S40), the encoder 24 sends data parameters of the motor unit 22 to the servo driver 10 (step S50). At this point, the servo driver 10 acknowledges the identification of the motor unit 22. Finally, the servo driver 10 controls the motor unit 22 according to the data parameters of the motor unit 22 (step S60), to perform tasks such as decoupling compensation, reducing cogging torque or flux-weakening control.

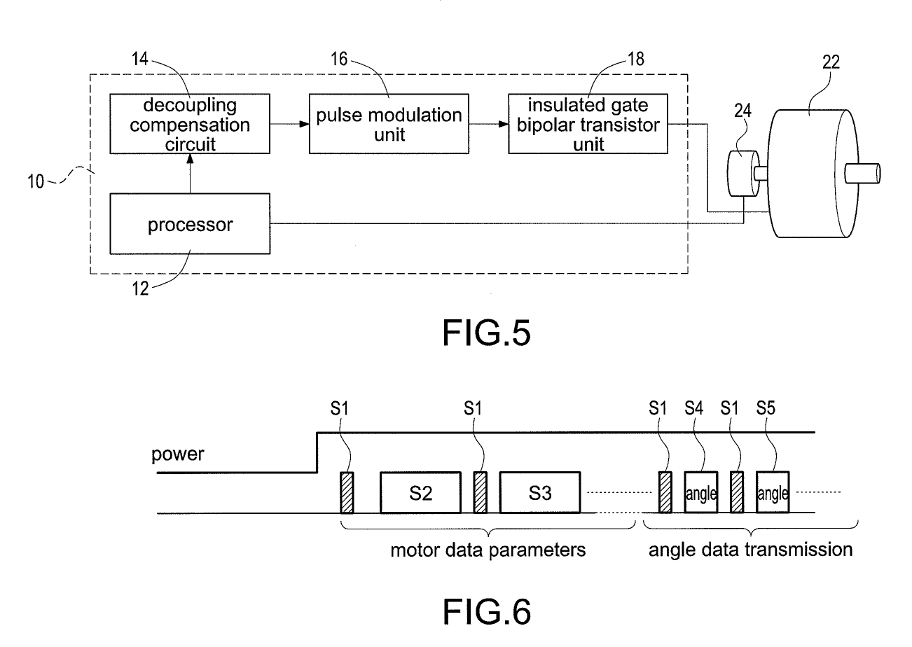

FIG. 5 is a schematic diagram illustrating decoupling compensation of servo motor system according to the present invention. The encoder 24 (for example an absolute encoder) provides an absolute angle as a basis to offer correct compensation on physical characteristics related to angle of the rotator. For example, the wave form of three-phase counter-electromotive force of the IPM motor is an approximate trapezoid. Following power on, the processor 12 of the servo driver 10 receives the wave form of the counter-electromotive force of the motor unit 22 from the encoder 24. Subsequently, the processor 12 of the servo driver 10 controls a decoupling compensation circuit 14, a pulse modulation unit 16 and an insulated gate bipolar transistor unit 18 to offer compensation for delivering steady control over the torque.

FIG. 6 is an operating timing diagram of a servo driver and an encoder according to the present invention. In FIG. 6, S1 represents the motor identification code sent from the servo driver 10 to the encoder 24. Each servo motor 20 is assigned a unique motor identification code when the servo motor 20 is installed in a servo motor system. As a result, the servo driver 10 uses the motor identification codes as the basic critical data for recognizing a servo motor 20. The data parameters corresponding to the motor identification code are saved in the memory unit 24B of the encoder 24. In FIG. 6, S2˜S5 represents data corresponding to the motor identification code replied from the encoder 24 to the servo driver 10. In the beginning, the servo driver 10 is power on, and then the servo driver 10 starts to retrieve complete motor data parameters (for example S2, S3 etc. . . . in FIG. 6). Following that, real-time feedback on angles and positions are generated (for example S4, S5 etc . . . ). In an example, S2 is the resistance data of motor unit 22 on direct axis (d axis) and quadrature axis (q axis); and S3 is the inductance data of the motor unit 22 on direct axis (d axis) and quadrature axis (q axis). The real-time feedback on angles and positions are generated only when complete motor data parameters are retrieved by the servo driver 10.

The data parameters saved in the memory unit 24B of the encoder 24 are determined by measuring equipment in production of the servo motor 20, and then the data parameters are saved to the memory unit 24B of the encoder 24. Each motor has different data parameters. Different data parameters of the servo motor 20 are received by the servo driver 10 used to achieve unified performance among motors. In other words, the differences of characteristics among different motor units 22 are reduced.

With the rapid development of technology, servo motor designs are upgraded in order to cover various demands. As a result, it is required to update the firmware of the servo driver as the hardware upgrades. Yet, the update task is costly and labor consuming. The present invention provides mechanism to update the firmware for waiving the cost and labor previously required for firmware update. The major technical features of the present invention include:

1. The encoder 24 has the CPU 24A and the memory unit 24B. The memory unit 24B is used for saving the data parameters of the motor unit 22, angle related counter-electromotive forces and waveforms of cogging torque.

2. Upon the servo driver 10a is power on, the servo driver 10a offers feedback on real-time angle and position after the servo driver 10a retrieves all parameters of the motor unit 22. The servo driver 10 offers compensation based on the data parameters of the motor unit 22 in order to deliver steady performance and high operating efficiency of the motor unit 22.

3. The data parameters saved in the memory unit 24B of the encoder 24 are determined by measuring equipment in production of the servo motor 20, then the data parameters are saved to the memory unit 24B of the encoder 24.

4. Correct compensation requires angle data of the rotor in an IPM motor. The absolute encoder provides an absolute angle as a basis to offer correct compensation on physical characteristics related to angle of the rotator.

The advantages of the present invention are:

1. The servo driver 10 is capable of driving an upgraded servo motor 20.
2. The differences of characteristics among different motor units 22 are reduced.

As the skilled person will appreciate, various changes and modifications can be made to the described embodiments. It is intended to include all such variations, modifications and equivalents which fall within the scope of the invention, as defined in the accompanying claims.

What is claimed is:

1. A servo motor system having a servo motor, the servo motor further comprising:
a motor unit; and
an encoder mechanically connected to the motor unit, the encoder further comprising:
a CPU; and
a memory unit electrically connected to the CPU, data parameters being saved in the memory unit.

2. The servo motor system of claim 1, wherein the servo motor system further comprises a servo driver electrically connected to the servo motor, and the servo driver uses data parameters of the motor unit saved in the memory unit for controlling the motor unit.

3. The servo motor system of claim 1, wherein the servo motor is an interior permanent magnet motor.

4. The servo motor system of claim 3, wherein the encoder is an absolute encoder.

5. The servo motor system of claim 4, wherein data parameters saved in the memory unit comprise resistance, inductance, counter-electromotive force, detent torque of the motor unit on direct axis and quadrature axis.

6. A operating method of a servo motor system used with a servo driver and a servo motor, the servo motor having a motor unit and an encoder, the encoder having a CPU and a memory unit, data parameters being saved in the memory unit, the method comprising:
A. retrieving data parameters of the motor unit from the memory unit by the CPU;
B. sending data parameters of the motor unit to the servo driver by the encoder; and
C. controlling the motor unit according to the data parameters of the motor unit by the servo driver.

7. The operating method of claim 6, wherein the method further comprises a step A1 prior to the step A: making a request to the encoder to send data parameters of the motor unit by the servo driver.

8. The operating method of claim 7, wherein the method further comprises a step A2 prior to the A1: sending a motor identification code to the servo driver by the servo motor.

9. The operating method of claim 6, wherein the servo motor is an interior permanent magnet motor, and the encoder is an absolute encoder.

10. The operating method of claim 9, wherein data parameters saved in the memory unit comprise resistance, inductance, counter-electromotive force, detent torque of the motor unit on direct axis and quadrature axis.
